(19) United States
(12) Patent Application Publication
(10) Pub. No.: US 2010/0243615 A1
(43) Pub. Date: Sep. 30, 2010

(54) WELDING APPARATUS AND METHODS

(75) Inventor: Jeffrey Angel, Lake Orion, MI (US)

Correspondence Address: GIFFORD, KRASS, SPRINKLE,ANDERSON & CITKOWSKI, P.C, PO BOX 7021, TROY, MI, 48007-7021, US

(73) Assignee: Milco Manufacturing Company, Warren, MI (US)

(21) Appl. No.: 12/729,853

(22) Filed: Mar. 23, 2010

Related U.S. Application Data
(60) Provisional application No. 61/162,814, filed on Mar. 24, 2009.

(51) Int. Cl. B23K 11/30

(52) U.S. Cl. 219/117.1; 219/119; 336/192

(57) ABSTRACT

A welding apparatus comprises a first electrode; a second electrode opposite the first electrode, the second electrode being movable toward and away from the first electrode; a third electrode; a fourth electrode opposite the third electrode, the fourth electrode being movable toward and away from the third electrode; a first transformer winding adapted to be coupled to a power source; a second transformer winding electromagnetically coupled to the first transformer winding and the first and second electrodes; and a third transformer winding electromagnetically coupled to the first transformer winding and the third and fourth electrodes; the first transformer winding substantially evenly transferring current to the second transformer winding and the third transformer winding when energized by the power source, such that the first and second electrodes are energized substantially simultaneously with the third and fourth electrodes.

### REFERENCE TO RELATED APPLICATIONS

This U.S. patent application claims priority from U.S. provisional patent application Ser. No. 61/162,814, filed Mar. 24, 2009, the entire content of which is incorporated herein by reference.

### FIELD OF THE INVENTION

The present invention relates generally to apparatus and methods for welding, and more particularly to a resistance welding apparatus having multiple sets of simultaneously energizable electrodes.

### BACKGROUND OF THE INVENTION

Resistance welding is used in various applications where it is desired to join two or more metal materials together. Conventional resistance welding systems include opposed electrodes that are brought toward one another to engage a workpiece, which may include two or more metal materials. The workpiece is clamped between the electrodes and current is applied to the electrodes. The combination of heat and pressure at the contact points of the electrodes fuses the materials together.

In certain applications, it may be desired to weld two or more locations of a workpiece simultaneously. Conventional welding systems that utilize multiple sets of electrodes have either used individual transformers associated with each set of welding electrodes, or have used a single transformer operated in a cascaded fashion to energize each set of electrodes separately and sequentially.

A need exists for an improved welding apparatus having multiple sets of electrodes that can be energized simultaneously and which can be provided in a compact package suitable for mounting on the manipulators of a robot.

### SUMMARY OF THE INVENTION

In one aspect, a welding apparatus comprises a first electrode; a second electrode opposite the first electrode, the second electrode being movable toward and away from the first electrode; a third electrode; a fourth electrode opposite the third electrode, the fourth electrode being movable toward and away from the third electrode; a first transformer winding adapted to be coupled to a power source; a second transformer winding electromagnetically coupled to the first transformer winding and the first and second electrodes; and a third transformer winding electromagnetically coupled to the first transformer winding and the third and fourth electrodes; the first transformer winding substantially evenly transferring current to the second transformer winding and the third transformer winding when energized by the power source, such that the first and second electrodes are energized substantially simultaneously with the third and fourth electrodes.

The welding apparatus can further comprise a first diode associated with the second transformer winding; and a second diode associated with the third transformer winding; the first and second diodes converting alternating current received from the power source through the first transformer winding into direct current. The first and second transformer windings can share a common termination. The welding apparatus can further comprise a first actuator operatively coupled to the second electrode; and a second actuator operatively coupled to the fourth electrode; the first and second actuators operable to substantially simultaneously move the second and fourth actuators toward the first and third electrodes, respectively. The welding apparatus can further comprise an actuator operatively coupled to the second electrode and to the fourth electrode; the actuator operable to simultaneously move the second actuator toward said first electrode and to move the fourth actuator toward the third electrode. The welding apparatus can further comprise at least one sensor configured to measure current associated with at least one of the first transformer winding, the second transformer winding, or the third transformer winding.

In another aspect, a welding apparatus comprises a first electrode; a second electrode opposite the first electrode, the second electrode being movable toward and away from the first electrode; a third electrode; a fourth electrode opposite the third electrode, the fourth electrode being movable toward and away from the third electrode; a first transformer winding adapted to be coupled to a power source; and a second transformer winding electromagnetically coupled to the first transformer winding and being center tapped to provide a first output and a second output; the first output electrically coupled to the first and second electrodes; the second output electrically coupled to the third and fourth electrodes; the first transformer winding substantially evenly transferring current to the first and second outputs of the second transformer winding when energized by the power source, such that the first and second electrodes are energized substantially simultaneously with the third and fourth electrodes.

The welding apparatus can further comprise a first diode associated with the first output of the secondary transformer winding; and a second diode associated with the second output of the secondary transformer winding; the first and second diodes converting alternating current received from the power source through the first transformer winding into direct current.

In yet another aspect, a method of welding two structures comprises energizing a first transformer winding; transferring energy from the first transformer winding to second and third transformer windings electromagnetically coupled to the first transformer winding; energizing first and second opposing electrodes using the second transformer winding; and energizing third and fourth opposing electrodes substantially simultaneously with the first and second electrodes using the third transformer winding.

The method can further comprise moving the second electrode toward the first electrode; and moving the fourth electrode toward the third electrode substantially simultaneously with the movement of the second electrode toward the first electrode. The method can further comprise sensing current in at least one of the first transformer winding, the second transformer winding, or the third transformer winding.

### BRIEF DESCRIPTION OF THE DRAWINGS

FIG. 1 is a perspective view of an exemplary welding apparatus in accordance with the principles of the present disclosure.

FIG. 1A is a perspective view, similar to FIG. 1, depicting a workpiece engaged by multiple sets of electrodes.

FIG. 2 is a cross-sectional view of the welding apparatus of FIG. 1, taken along line 2-2.

FIG. 3 is an end view of the welding apparatus of FIG. 1.

FIG. 4 is top plan view of the welding apparatus of FIG. 1.

FIG. 5 is an elevational view of the welding apparatus of FIG. 1, with hidden lines illustrating detail of the welding apparatus.

FIG. 6A is a schematic representation of an exemplary transformer for use with the welding apparatus of FIG. 1.

FIG. 6B is a schematic representation of another exemplary transformer for use with the welding apparatus of FIG. 1.

FIG. 6C is a schematic representation of yet another exemplary transformer for use with the welding apparatus of FIG. 1.

### DETAILED DESCRIPTION OF THE INVENTION

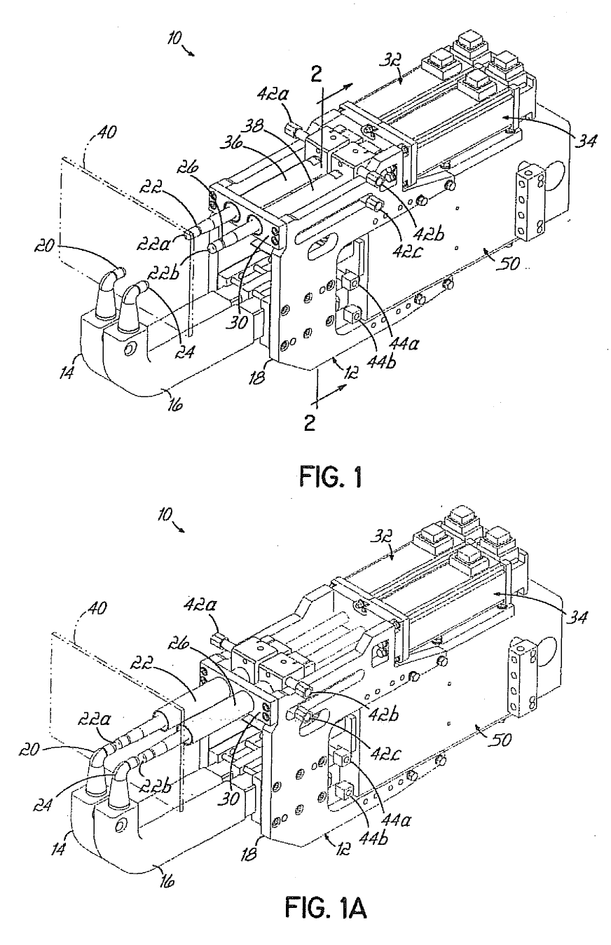

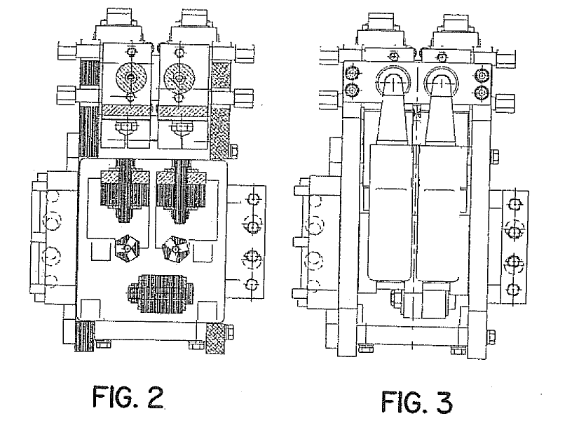

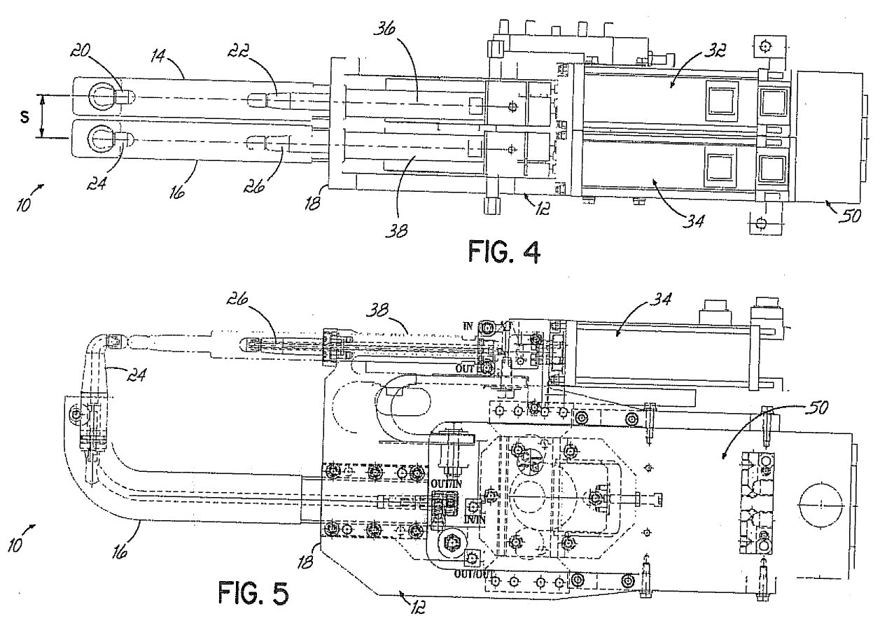

FIG. 1 depicts an exemplary welding apparatus 10 in accordance with the principles of the present disclosure. The welding apparatus 10 includes a housing 12 that encloses and supports various components of the welding apparatus 10. The housing 12 may be configured to be mounted to a support structure or to a robotic manipulator to facilitate use of the welding apparatus 10 in production environments. First and second electrode arms 14, 16 extend outwardly from a first end 18 of the housing 12. A first electrode 20 is supported on the first electrode arm 14 and is fixed in position with respect to the housing 12. A second electrode 22 is positioned opposite the first electrode 20 and is supported on the housing 12 for movement toward and away from the first electrode 20.

A third electrode 24 is supported on the second electrode arm 16, adjacent the first electrode 20, and is fixed in position with respect to the housing 12. A fourth electrode 26 is positioned opposite the third electrode 24 and is supported by the housing 12 for movement toward and away from the third electrode 24, in a manner similar to the second electrode 22. The tips 22a, 26a of the second and fourth electrodes 22, 26 extend through a guide plate 30 coupled to the housing 12. First and second actuators 32, 34 are coupled to the second and fourth electrodes 22, 26 by respective adapters 36, 38, whereby actuation of the first and second actuators 32, 34 controls movement of the adapters 36, 38 and the second and fourth electrodes 22, 26 in directions toward and away from the first and third electrodes 20, 24, respectively. Accordingly, when it is desired to perform a welding operation, a workpiece 40 may be positioned generally adjacent the first and third electrodes 20, 24 and the first and second actuators 32, 34 may be actuated to move the second and fourth electrodes 22, 26 toward the first and third electrodes 20, 24 to thereby clamp the workpiece 40 between the respective pairs of electrodes 20, 22, 24, 26, as depicted in FIG. 1A.

The actuators 32, 34 may be any device that is suitable for selectively moving the second and fourth electrodes 22, 26 toward and away from the first and third electrodes 20, 24, respectively. As non-limiting examples, the actuators 32, 34 may comprise servomotors; pneumatic, hydraulic, or electromagnetic cylinders; or any other suitable device. While the embodiments shown and described herein depict first and second actuators 32, 34 associated with the second and fourth electrodes 22, 26, respectively, it will be appreciated that the welding apparatus 10 may alternatively include only a single actuator that is operatively coupled to the second and fourth electrodes 22, 26 to move the second and fourth electrodes 22, 26 toward and away from the first and third electrodes 20, 24, respectively.

To maintain the electrodes 20, 22, 24, 26 within desired operating temperature ranges, the welding apparatus 10 may be configured to provide cooling water or other fluid to the tips of the electrodes 20, 22, 24, 26. Accordingly, the welding apparatus 10 may include various water lines 42a, 42b, 42c, 44a, 44b for providing cooling water or other suitable fluids to the respective electrodes. FIG. 5 depicts the general paths for providing cooling fluid to the tips of the electrodes 20, 22, 24, 26 as hidden lines.

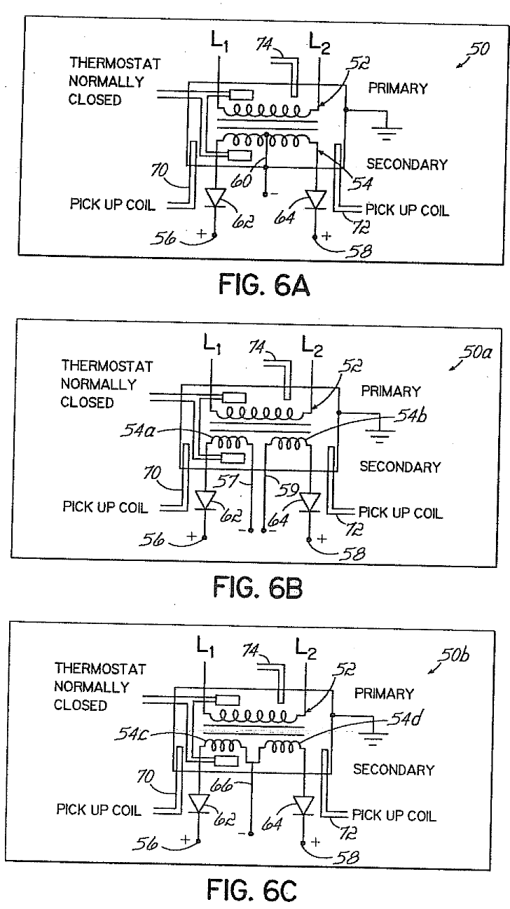

The welding apparatus 10 further includes a mid frequency DC transformer. To this end, a transformer 50 is coupled to the housing 12. The transformer 50 includes various electrical terminations that may be electrically coupled to the electrodes 20, 22, 24, 26, by various shunts for example, as known in the art. FIG. 6A is a schematic representation of an exemplary transformer 50 for use with the welding apparatus 10 of FIG. 1. The transformer 50 includes a first transformer winding 52 that is adapted to be coupled to a power source. A second transformer winding 54 is electromagnetically coupled to the first transformer winding 52 and has first and second terminations 56, 58 for coupling the second transformer winding 54 to the electrodes 20, 22, 24, 26. In this embodiment, the second transformer winding 54 also includes a center tap 60 defining a common termination that may be coupled to the electrodes 20, 22, 24, 26. For example, the first and second electrodes 20, 22 may be coupled to the first termination 56 and the center tap 60, respectively, and the third and fourth electrodes 24, 26 may be coupled to the second termination 58 and the center tap 60, respectively. The center tap 60 is located on the second transformer winding 54 such that current is substantially evenly transferred from the first transformer winding 52 to the respective electrode pairs 20-22, 24-26 when the first transformer winding 52 is energized by the power source. The first and second electrodes 20, 22 are therefore energized substantially evenly and simultaneously with the third and fourth electrodes 24, 26 when the first transformer winding 52 is energized by the power source.

The second transformer winding 54 may further include first and second diodes 62, 64 associated with the first and second terminations 56, 58, respectively, whereby alternating current, for example 480 V AC, provided to the first transformer winding 52 from the power source is converted to direct current, for example 130 KVA DC, by the secondary transformer winding 54 and supplied to the respective electrode pairs 20-22, 24-26.

The transformer 50 may also include one or more sensors for monitoring current associated with the transformer windings. In the embodiment shown, a first sensor 70 is positioned proximate the first termination 56 of the second transformer winding 54 and senses current through the first termination 56. A second sensor 72 may be positioned proximate the second termination 58 of the second transformer winding 54 to sense current through the second termination 58. A third sensor 74 may be positioned proximate the first transformer winding 52 to sense current through the first transformer winding 52. In the embodiment shown, each of the first, second, and third sensors 70, 72, 74 comprises an electrical coil having a single turn, whereby electric current associated with the respective transformer windings 52, 54 may be sensed by the sensors 70, 72, 74. It will be appreciated that the first, second, and third sensors 70, 72, 74 may alternatively comprise various other types of sensors suitable for sensing current associated with the first and second transformer windings 52, 54.

FIG. 6B is a schematic representation of yet another exemplary transformer 50a for use with the welding apparatus 10 of FIG. 1. Features of the transformer 50a that are similar to the respective features of transformer 50 of FIG. 6A are similarly numbered. In this embodiment, the welding apparatus 10 includes a mid frequency DC transformer with a single primary and dual secondary loops powering the welding apparatus 10. To this end, a first transformer winding 52 is adapted to be coupled to a power source (not shown) and separate second and third transformer windings 54a, 54b are electromagnetically coupled to the first transformer winding 52. The second and third transformer windings 54a, 54b each include distinct terminations 56, 57, 58, 59 that may be coupled to one of the respective electrodes 20, 22, 24, 26. The second and third transformer windings 54a, 54b are configured such that current is substantially evenly transferred from the first transformer winding 52 to the second and third transformer windings 54a, 54b when the first transformer winding 52 is energized by the power source. Accordingly, the first and second electrodes 20, 22 will be energized substantially evenly and simultaneously with the third and fourth electrodes 24, 26.

The transformer 50a of FIG. 6B may include first and second diodes 62, 64 associated with the second and third transformer windings 54a, 54b to convert alternating current provided to the first transformer winding 52 into direct current that is provided to the electrodes 20, 22, 24, 26, as discussed above with respect to FIG. 6A. Transformer 50a may also include first, second, and third sensors 70, 72, 74 for sensing current associated with the first, second, and third windings 52, 54a, 54b, in a manner similar to that described above for transformer 50 of FIG. 6A.

FIG. 6C depicts yet another embodiment of a transformer 50b for use with the welding apparatus 10 of FIG. 1. Features of the transformer 50b that are similar to the respective features of transformer 50a of FIG. 6B are similarly numbered. In this embodiment, a first transformer winding 52 is adapted to be coupled to a power source (not shown). Second and third transformer windings 54c, 54d are electromagnetically coupled to the first transformer winding 52 and share a common termination 66. The second and third transformer windings 54c, 54d are configured such that current is substantially evenly transferred from the first transformer winding 52 to the second and third transformer windings 54c, 54d when the first transformer winding 52 is energized by the power source. Accordingly, the first and second electrodes 20, 22 may be coupled to a first termination 56 of the second transformer winding 54c and to the common termination 66, respectively, while the third and fourth electrodes 24, 26 are coupled to the second termination 58 of the third transformer winding 54d and to the common termination 66, respectively. Current is therefore provided to the first and second electrodes 20, 22 substantially evenly and simultaneously with current provided to the third and fourth electrodes 24, 26.

The transformer 50b of FIG. 6C may include first and second diodes 62, 64 associated with the second and third transformer windings 54c, 54d to convert alternating current provided to the first transformer winding 52 to direct current that is provided to the electrodes 20, 22, 24, 26, as discussed above with respect to FIG. 6A. Transformer 50b may also include first, second, and third sensors 70, 72, 74 for sensing current associated with the first, second, and third windings 52, 54c, 54d, in a manner similar to that described above for transformer 50a of FIG. 6B.

In use, a workpiece 40 may be positioned generally adjacent the first and third electrodes 20, 24 of the welding apparatus 10, as depicted in FIG. 1. The first and second actuators 32, 34 may be actuated to move the second and fourth electrodes 22, 26 toward the first and third electrodes 20, 24 so that the workpiece 40 is clamped between the respective electrode pairs 20-22, 24-26. The power source then energizes the first transformer winding 52. When the transformer 50 is configured as depicted in FIG. 6A, the second transformer winding 54 is energized by the first transformer winding 52 so that the first and second electrodes 20, 22 are energized substantially evenly and simultaneously with the third and fourth electrodes 24, 26 to weld the workpiece 40 in two locations substantially simultaneously. When the transformer 50a, 50b is configured as depicted in FIG. 6B or 6C, the second and third transformer windings 54a, 54b, 54c, 54d are energized by the first transformer winding 52 so that the first and second electrodes 20, 22 are energized substantially evenly and simultaneously with the third and fourth electrodes 24, 26 to weld the workpiece 40 in two locations substantially simultaneously.

While the embodiments shown and described herein have depicted two pairs of electrodes 20-22, 24-26 for simultaneously welding a workpiece 40 in two locations, it will be appreciated that the welding apparatus 10 may alternatively include three or more pairs of electrodes, as may be desired, for simultaneously welding more than two locations on a workpiece 40. Such a welding apparatus will require a transformer configured with an appropriate number of windings or taps in the secondary stage to accommodate the desired number of electrode pairs.

It will be appreciated that, while the embodiments shown and described herein have depicted the first and second electrodes 20, 22 as being supported on a housing 12 at a fixed distance from the third and fourth electrodes 24, 26, the welding apparatus 10 may alternatively be configured to permit adjustment of the spacing between the pairs of electrodes 20-22, 24-26, as may be desired, so that the welding apparatus 10 can be adjusted to suit various applications.

The various embodiments of the welding apparatus 10 described above provide a number of advantages over and above current apparatus. AC current coming into the transformer (single primary loop) is transformed into two secondary loops of substantially identical DC current. Sensors monitor the current on the primary side and the secondary side insuring weld quality. This allows the use of one transformer to weld two spots at the same time with a specially configured weld gun that has dual actuators and dual arms but which share one transformer. The transformer has a single tap ground that both of the lower arms attach to and with two separate positive pads that complete the circuit to each of the two actuator shanks. The mid frequency transformer has separate diodes on each side of the secondary loop to create the DC current. The geometry of the dual weld gun herein is about the same size as a conventional single weld gun due to the power (2,000 pounds) versus the size (approximately 2.25 inches squared) of the servo motors (a suitable one of which is manufactured by Exlar under part number GSX30), and due to the fact that the transformer can produce 130 KVA on each side of the two secondary loops at the same size of a single transformer due to the packaging of the diodes. AC current used in conventional weld guns does not allow two electromagnetic loops to be positioned side by side. DC current does not have the same characteristics and does not experience a loss in current from the loops. Previously, if a multiple gun application was used utilizing one transformer, it was cascaded, firing each gun separately. To fire simultaneously, a conventional dual gun must utilize a separate transformer for each gun, greatly increasing the size and cost of the assembly. The dual weld gun herein fires substantially simultaneously, thus welding faster, but utilizes only a single transformer, thus reducing size. The dual weld gun herein is thus smaller, less expensive, and welds faster and more accurately than conventional weld guns.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of the general inventive concept.

What is claimed is:

1. A welding apparatus, comprising:
a first electrode;
a second electrode opposite said first electrode, said second electrode being movable toward and away from said first electrode;
a third electrode;
a fourth electrode opposite said third electrode, said fourth electrode being movable toward and away from said third electrode;
a first transformer winding adapted to be coupled to a power source;
a second transformer winding electromagnetically coupled to said first transformer winding and said first and second electrodes; and
a third transformer winding electromagnetically coupled to said first transformer winding and said third and fourth electrodes;
said first transformer winding substantially evenly transferring current to said second transformer winding and said third transformer winding when energized by the power source, such that said first and second electrodes are energized substantially simultaneously with said third and fourth electrodes.

2. The welding apparatus of claim 1, further comprising:
a first diode associated with said second transformer winding; and
a second diode associated with said third transformer winding;
said first and second diodes converting alternating current received from the power source through said first transformer winding into direct current.

3. The welding apparatus of claim 1, wherein said first and second transformer windings share a common termination.

4. The welding apparatus of claim 1, further comprising:
a first actuator operatively coupled to said second electrode; and
a second actuator operatively coupled to said fourth electrode;
said first and second actuators operable to substantially simultaneously move said second and fourth actuators toward said first and third electrodes, respectively.

5. The welding apparatus of claim 1, further comprising:
an actuator operatively coupled to said second electrode and to said fourth electrode;
said actuator operable to simultaneously move said second actuator toward said first electrode and to move said fourth actuator toward said third electrode.

6. The welding apparatus of claim 1, further comprising:
at least one sensor configured to measure current associated with at least one of said first transformer winding, said second transformer winding, or said third transformer winding.

7. A welding apparatus, comprising:
a first electrode;
a second electrode opposite said first electrode, said second electrode being movable toward and away from said first electrode;
a third electrode;
a fourth electrode opposite said third electrode, said fourth electrode being movable toward and away from said third electrode;
a first transformer winding adapted to be coupled to a power source; and
a second transformer winding electromagnetically coupled to said first transformer winding and being center tapped to provide a first output and a second output;
said first output electrically coupled to said first and second electrodes;
said second output electrically coupled to said third and fourth electrodes;
said first transformer winding substantially evenly transferring current to said first and second outputs of said second transformer winding when energized by the power source, such that said first and second electrodes are energized substantially simultaneously with said third and fourth electrodes.

8. The welding apparatus of claim 7, further comprising,
a first diode associated with said first output of said secondary transformer winding; and
a second diode associated with said second output of said secondary transformer winding;
said first and second diodes converting alternating current received from the power source through said first transformer winding into direct current.

9. A method of welding two structures, the method comprising:
energizing a first transformer winding;
transferring energy from the first transformer winding to second and third transformer windings electromagnetically coupled to the first transformer winding;
energizing first and second opposing electrodes using the second transformer winding; and
energizing third and fourth opposing electrodes substantially simultaneously with the first and second electrodes using the third transformer winding.

10. The method of claim 9, further comprising,
moving the second electrode toward the first electrode; and
moving the fourth electrode toward the third electrode substantially simultaneously with the movement of the second electrode toward the first electrode.

11. The method of claim 9, further comprising:
sensing current in at least one of the first transformer winding, the second transformer winding, or the third transformer winding.
